(19) United States
(12) Patent Application Publication
(10) Pub. No.: US 2015/0036520 A1
(43) Pub. Date: Feb. 5, 2015

(54) MONITORING OF A DIFFERENTIAL MULTICHANNEL TRANSMISSION LINK

(71) Applicants: Dirk Steinbuch, Wimsheim (DE); Raik Schnabel, Leonberg (DE)

(72) Inventors: Dirk Steinbuch, Wimsheim (DE); Raik Schnabel, Leonberg (DE)

(21) Appl. No.: 14/353,419

(22) PCT Filed: Aug. 28, 2012
(86) PCT No.: PCT/EP2012/066636

§ 371 Date: Sep. 2, 2014

(30) Foreign Application Priority Data
Oct. 27, 2011 (DE) 10 2011 085 280.8

(51) Int. Cl. H04L 12/26

(52) U.S. Cl. CPC H04L 43/08
USPC 370/252

(57) ABSTRACT

A monitoring device and to a method for monitoring a proper operational state of a transmission link having multiple channels, each of which is configured for the differential transmission of signals, including the following steps: feeding differential signals at a first end of the transmission link to be monitored; converting the signals received at a second end of the transmission link to be monitored into difference signals, a difference signal being formed for each channel; and comparing a quality criterion which is dependent on the distribution of the values of the difference signals to a threshold value. The quality criterion depends on the variance of the logarithms of the difference signals across the channels, for example.

### FIELD

The present invention relates to a method for monitoring a proper operational state of a transmission link for the differential transmission of a signal.

### BACKGROUND INFORMATION

Differential or symmetrical signal transmission is a common transmission technique. Due to its high interference resistance, it is used in particular for high frequency data transmission. During the differential transmission of a signal, the desired signal is transmitted on a first conductor, while a reference signal which is opposite to the desired signal, i.e., corresponds to the negative of the desired signal, for example, is simultaneously transmitted on a second conductor. At a receiving location of the transmission link, the differential signal component may be obtained by forming the difference signal from the signal and the reference signal, the amplitude corresponding to double the desired signal, and interferences which equally impact both conductors being able to be eliminated or reduced by creating the difference.

It is conventional to monitor a proper operational state of a differential signal transmission link to increase the reliability.

European Patent No. EP 0 621 702 A2 describes a circuit for monitoring the proper operational state of the signal lines of a transmission link on which the difference signals may be transmitted bidirectionally, in that one signal line takes on the potential +5 V of a supply voltage source and the other signal line takes on the potential 0 V of a ground reference. A bridge rectifier is hooked up to the signal lines of the transmission link and connected to a comparator. The bridge rectifier converts the constant change of the difference signals on the signal lines into a constant potential at the output electrodes when the transmission link is functioning properly. When a defined voltage fails to be present at the output of the bridge rectifier in a faulty state of the signal lines, the circuit forces a voltage at the comparator having a sign which is reversed as compared to the derived voltage, so that the output signal of the comparator indicates the faulty functional state of the signal lines.

German Patent Application No. DE 102 37 696 B3 describes a method and a device for identifying a transmission fault on a data line using a differential signaling technique. A mid-level value in a mid-potential range between the two signal levels of the two signal lines is evaluated for detecting a fault. The mid-level value remains unchanged when the transmitted binary information changes, i.e., when a switch takes place from a logic “1” to a logic “0,” or vice versa. In the event of a fault, such as a short of a signal conductor to ground, the mid-level value shifts and a fault signal is generated. To detect the signal levels, two sample and hold devices are used, one of which is used to detect the mid-level value in the case of a logic “1” and the other to detect the mid-level value in the case of a logic “0.” The measuring variables stored by the two sample and hold devices are used to generate the fault signal.

### SUMMARY

Conventional monitoring devices for a differential signal transmission link require additional circuits on the signal lines to detect a fault. The circuitry complexity thus increases for a multichannel transmission link.

In addition, conventional monitoring circuits which are adapted to the transmission of binary signals are not usable for monitoring when signals are transmitted which have continuously varying signal amplitudes, or signal amplitudes which vary by more than two values.

It is an object of the present invention to provide a method for monitoring a proper operational state of a transmission link having multiple differential channels which may be used to reliably detect a signal drop, such as that which occurs, for example, in the case of a rupture or a short circuit of a conductor of a differential channel.

In accordance with the present invention, an example method is provided for monitoring a proper operational state of a transmission link having multiple channels, each of which is configured for the differential transmission of signals, including the following steps:
feeding differential signals at a first end of the transmission link to be monitored;
converting the signals received at a second end of the transmission link to be monitored into difference signals, a difference signal being formed for each channel;
comparing a quality criterion which is dependent on the distribution of the values of the difference signals of the channels to a threshold value. For example, a function signal, which identifies a malfunction in at least one of the channels, is generated as a function of the comparison result.

The example method allows the detection of a fault solely be evaluating transmitted signals, i.e., without measuring additional parameters.

The quality criterion preferably depends on the distribution of the logarithms of the difference signals of the channels. In this way, a change, in particular a drop, of a signal level by a minimum value d may be detected particularly well, i.e., a change relative to the logarithm of the difference signal. The analysis of the logarithmic values of the difference signals and of the signal drop to be detected preferably lends itself to detect a signal drop which has a multiplicative effect on the signal voltage. For example, a drop by 6 dB, corresponding to a cut of the voltage in half or a cut of the signal energy in half, occurs when one of the two conductors of a channel does not supply a signal. Here and hereafter, the decadic logarithm is preferably used as the logarithm.

The quality criterion is preferably dependent on the variance of the difference signals across the channels, particularly preferably on the variance of the logarithms of the difference signals across the channels. The quality criterion is calculated from the logarithms of the difference signals of the channels, for example.

The fed differential signals are test signals, for example.

The method preferably includes the step of digitizing the formed difference signals. The comparison step may then advantageously be carried out by a data processing unit. If the received signals are processed by a data processing unit anyhow, the comparison step may be carried out on the receiver side by the data processing unit, so that the implementation of the method is particularly simplified. Since the quality criterion is only dependent on the received difference signals, the difference signals of the channels are the only measuring variables on which the comparison is based. The comparison may thus be carried out based on digitized difference signals. This is particularly advantageous when a digitization of received difference signals is provided for anyhow during the operation of the transmission link. Additional evaluation circuits which cause costs and require printed circuit board space are then unnecessary.

In the comparison step, a threshold value σₜₕ², for which the condition (equation 1)

$${σ}_{tk}^{2} > \frac{n}{n - 1} \cdot \frac{{a}^{2}}{4} \qquad ( 1 )$$

is satisfied, is preferably compared to the quality criterion in the form of the variance (equation 2)

$${σ}^{2} = \frac{1}{n - 1} \cdot {\sum }_{i = 1}^{\text{?}} {( {x}_{i} - μ )}^{2} \\ \text{?} \text{indicates text missing or illegible when filed} \qquad ( 2 )$$

where:

a is the range a of the difference signals to be expected in the functioning state of the transmission link, defined as the difference between the largest and the smallest values of the logarithmic difference signals of the channels: a=max(x₁, . . . , xₙ)−min (x₁, . . . , xₙ) ;

n is the number of the differential channels;

x₁ , . . . , xₙ are the logarithms of the difference signals of channels 1 through n; and

A is the mean value of the logarithms of the difference signals of the channels, i.e., the arithmetic mean of x₁, . . . , xₙ.

This allows a drop d of the logarithmic difference signal of a channel by a value (equation 3)

d=\sqrt{4n·σₜₕ²} (3)

to be reliably detected, since the variance σ² assumes at least the threshold value σₜₕ² in the case of such a signal drop. In particular a drop by d may be reliably detected in as many as n−1 channels. In addition, the condition of equation (1) ensures that the threshold value is not reached in the functioning state of the transmission link. Incorrect fault detection is thus precluded. Moreover, in addition to a faulty signal drop, a faulty signal rise by at least d in one or multiple channels may be detected by the comparison to the threshold value.

For example, if in the case of a transmission link having n=4 differential channels, difference signals whose range a is smaller than 2.57 dB are to be expected for the fed differential signals in the functioning state of the transmission link, a drop of d=6 dB in one channel, in particular even in up to three channels, may be reliably detected by selecting the threshold value of σₜₕ²=2.25.

A drop by 6 dB, which corresponds to a cut of the difference signal in half, occurs, for example, in the case of a rupture in which a conductor of a channel is interrupted, so that only half the value of the signal voltage is available for converting the received signal into the difference signal. Detecting such a functional fault is of great practical importance if the evaluation of received signals is based on the amplitudes, in particular the relative amplitudes of the difference signals of the channels.

To detect a channel fault which has a subtractive or additive effect on the signal voltage, the processing of the logarithmic values as described above and hereafter may be appropriately replaced with the processing of the non-logarithmized values. The values x₁, . . . , xₙ are then the difference signals of the channels 1 through n, μ is their mean value, a=max(x₁, . . . , xₙ)−min(x₁, . . . , xₙ) is their range, and d corresponds to the magnitude of the absolute drop or rise of the difference signal of a channel to be detected. For example, at a particular minimum signal voltage at the receiving location in the functioning state, a signal drop which corresponds to a cut of the voltage in half may also be interpreted as a subtractive drop by a signal voltage which is dependent on the signal value, and may be treated as a subtractive drop by at least a minimum drop d (d>0). If the above equation (1) is satisfied for the range a of the non-logarithmized difference signals, it may again be ensured that the threshold value which satisfies equation (3) is not reached in the functioning state of the transmission link.

The object is further achieved by a monitoring device for a transmission link having multiple channels, each of which is configured for differential transmissions of signals, including:
at least one converter for converting received differential signals of the transmission link to be monitored, the at least one converter being configured to form a difference signal for each channel; and
a comparator, which is configured to compare a quality criterion which is dependent on the distribution of the values of the difference signals across the channels to a threshold value and to generate a function signal as a function of the result of the comparison.

### BRIEF DESCRIPTION OF THE DRAWINGS

Exemplary embodiments of the present invention are shown in the drawings and are described in greater detail below.

FIG. 1 shows a block diagram of a circuit having a multichannel differential signal transmission link and a monitoring device for the same.

FIG. 2 shows a diagram to illustrate the distinguishability of an intact transmission link and a transmission link having a level drop.

FIG. 3 shows a flow chart of a method for monitoring a proper operational state of a multichannel differential signal transmission link.

### DETAILED DESCRIPTION OF EXAMPLE EMBODIMENTS

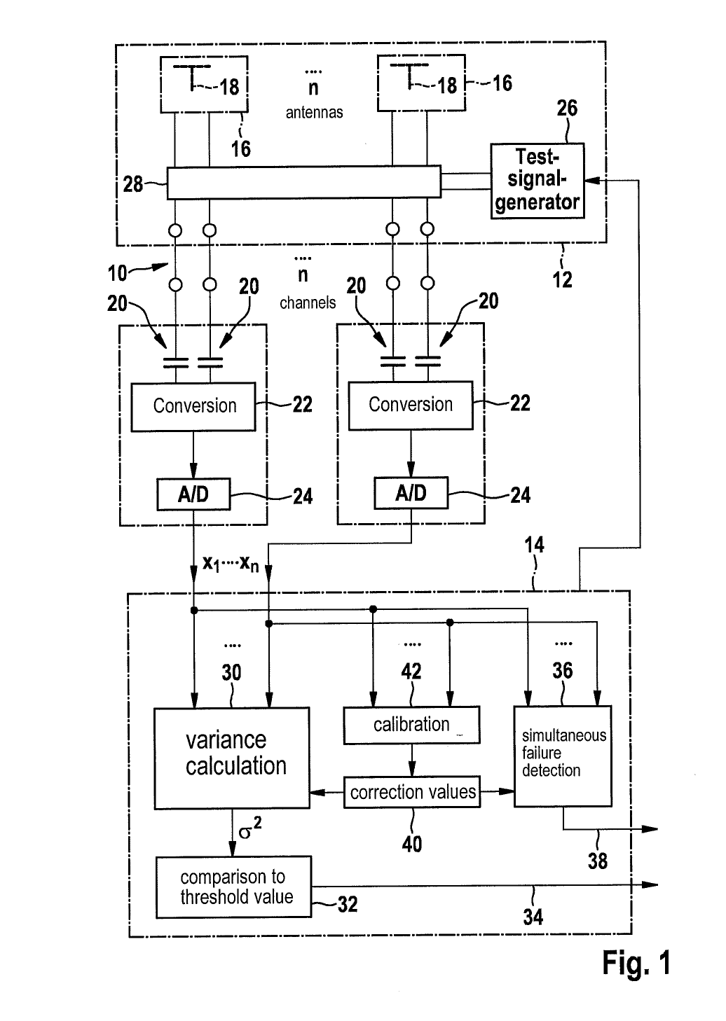

The circuit shown in FIG. 1 includes a transmission link 10 having multiple channels, each of which is configured for the differential transmission of signals. The number of channels is denoted by n. The channel count n is preferably greater than or equal to 2, in particular greater than or equal to 4. The channel count is 4, for example (i.e., n=4).

The circuit further includes at least one circuit module 12 and one data processing unit 14, which is connected to circuit module 12 via transmission link 10. For example, data processing unit 14 is configured to process, in particular evaluate, signals made available by circuit module 12, which are transmitted via transmission link 10 with the aid of the differential transmission technique. For example, data processing unit 14 is a processor-controlled data processing unit, e.g., a microcontroller, or an arithmetic logic unit (ALU).

Circuit module 12 is, for example, a semiconductor module for radar applications having transceiver modules 16 with integrated antenna elements 18 for sending and/or receiving radar signals. Radar signals received by antenna elements 18 are downmixed to a base frequency band in a conventional manner. Circuit module 12 is configured to provide the downmixed base band signals of the individual transceiver modules 16 in the form of differential signals and to feed them into transmission link 10.

At the other end of transmission link 10, the two conductors of a particular channel are AC voltage-coupled to a particular converter 22 via coupling capacitors 20. Converter 22 is configured to convert the received signal of one channel into a difference signal. For this purpose, the difference of the signals received from the two conductors of one channel is formed, so that possible interferences which equally impact both conductors of one channel are reduced or suppressed. In addition, any DC voltage components of a channel are suppressed by the AC voltage coupling of coupling capacitors 20 connected in series to the conductors.

The difference signal of a particular channel formed by converter 22 is digitized with the aid of an A/D converter 24 and made available to data processing unit 14 in the form of a digital value of a voltage level, in particular of the decadic logarithm of the difference signal. The logarithms of the difference signals are also referred to hereafter as logarithmic difference signals and are indicated as x₁ to xₙ for the particular channels 1 through n.

Data processing unit 14 is configured in a conventional manner to evaluate the base band signals of transceiver modules 16 obtained in the form of difference signals x₁ to xₙ for locating one or multiple objects. The circuit is part of a radar sensor, for example, in particular of a motor vehicle radar sensor for the distance and/or speed measurement of objects. For example, the radar sensor is an integral part of a motor vehicle radar system, in particular of a motor vehicle radar system of a driver assistance system. Depending on the architecture of the radar sensor, in particular the angle evaluation of located objects may be decisively based on the amplitudes of the difference signals.

If a conductor fails in one of the differential channels of transmission link 10, this may typically be caused by generally two fault mechanisms, which will be described hereafter. When a conductor or a coupling capacitor 20 ruptures, the corresponding converter input loses the electrical contact to the transmission link. As a result, the voltage available for processing by converter 22 decreases by half, in accordance with a drop of the difference signal by 6 dB. The voltage available for the conversion by converter 22 also drops by half when a conductor of a differential channel is shorted to ground or to the supply voltage Vcc. This also results in a drop of the difference signal by 6 dB.

Such defects are detectable by the monitoring device of the circuit described hereafter. It is thus possible to prevent faulty target interpretations of the radar sensor from occurring as a result of the incorrect signal levels. Detecting faulty connections of the described kind is particularly important with circuits in which circuit module 12 or transceiver modules 16 are implemented as integrated microwave circuits of the microwave monolithic integrated circuit (MMIC) type, and the differential base band signals are connected via external connecting elements, for example, 3D connecting structures in the form of solder balls, to an additional circuit part, such as a printed circuit board. For example, transceiver modules 16 are implemented as a wafer assembly of the embedded wafer level ball grid array (eWLB) type. The assembly is produced as an IC component having a contact redistribution layer for the IC component at the wafer level.

Circuit module 12 is configured to feed a test signal into the channels of transmission link 10. For example, circuit module 12 includes a test signal generator 26 and a switching device 28 to feed a differential test signal at the first end of transmission link 10 into the channels instead of the differential base band signals. Test signal generator 26 and switching device 28 are controlled by data processing unit 14 via an external control input, for example.

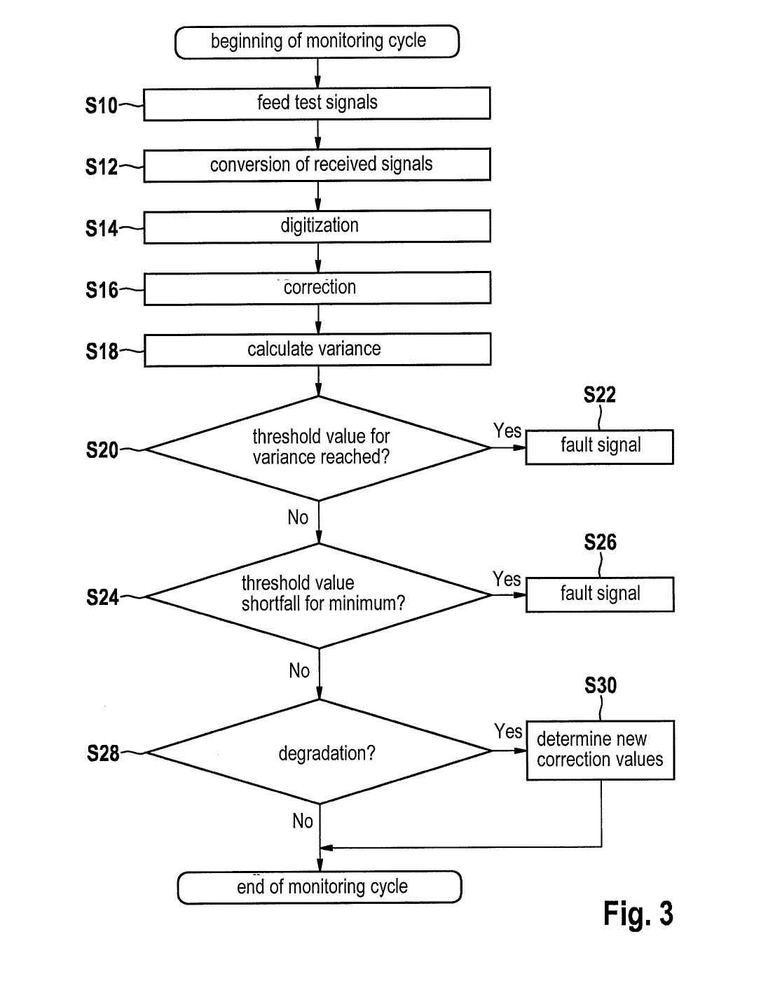

Data processing unit 14 triggers a monitoring cycle, for example, which includes the feeding of the test signal and will be described hereafter with reference to FIG. 3. The monitoring cycle is triggered at regular intervals, for example.

The test signal, which is preferably identical for all n channels, is converted at the other end of transmission link 10 in the same manner as the base band signals into difference signals with the aid of coupling capacitors 20 and converters 22 and is digitized with the aid of A/D converters 24. The obtained logarithmic difference signals x₁ through xₙ of the n channels are made available to a calculating unit 30. Calculating unit 30 is configured to calculate a quality criterion σₜₕ² which is dependent on the variance of the logarithms of the difference signals across the channels. The quality criterion is preferably variance σ² according to above equation (2).

A comparator 32 of data processing unit 14 is configured to compare the calculated quality criterion to the value for threshold value σₜₕ² resulting from above equation (3), the drop d to be detected having the value d=6 dB. The threshold value used for the comparison is thus (equation 4):

$${σ}_{th}^{2} = \frac{1}{n} \cdot {( \frac{d}{2} )}^{2} \qquad ( 4 )$$

When the quality criterion has reached the threshold value, i.e., σ²≧σₜₕ², comparator 32 outputs a corresponding function signal 34. This function signal 34 indicates that a voltage drop by 6 dB occurred on at least one of the n channels and thus identifies a corresponding defect of transmission link 10. Function signal 34 is made available to data processing unit 14, for example. An interrupt of data processing unit 14 may be triggered via function signal 34, for example. By comparing the quality criterion to the threshold value, a defined signal drop by d may be reliably detected in up to n−1 channels, i.e., up to 3 channels.

Data processing unit 14 optionally further includes a unit 36 for detecting a simultaneous failure of all n channels. For example, unit 36 is configured to compare the minimum of the logarithms of the difference signals of the n channels to a second threshold value, and to generate a second function signal 38, which identifies the simultaneous failure of all n channels, in the event of a threshold value shortfall. Function signal 38 may be evaluated in the same manner as first function signal 34. Function signals 34 and 38 may be interconnected or logically combined to form a common function signal which identifies a malfunction in at least one channel of the transmission link.

The monitoring of transmission link 10 is based on the fact that, in the proper operational state of transmission link 10, logarithmic difference signals x₁ through xₙ have a range a which satisfies above equation (1) when the test signal is fed. In the above definition of threshold value σₜₕ², the following must thus be satisfied (equation 5):

$$a < \sqrt{\frac{n - 1}{{n}^{2}} \cdot {d}^{2}} . \qquad ( 5 )$$

To keep range a of the difference signals preferably low in the functioning state of transmission link 10, a particular correction value may optionally be considered in the evaluation of the difference signals for calculating the variance or the minimum for one channel. Correction values 40 may be considered, for example, in the form of correction factors or correction summands for the difference signals. Correction values 40 may be stored in data processing unit 14 during a calibration, for example.

In addition, data processing unit 14 may optionally include a calibration unit 42, which is configured to calibrate correction values 40 based on difference signals x₁ through xₙ. For example, a calibration takes place when range a exceeds a calibration threshold value, which, however, is smaller than the maximally permissible range a according to equation (5). A calibration is preferably only carried out when quality criterion σ² does not reach its threshold value. With the aid of an automatic and autonomously conducted recalibration, a reduction of range a occurring in the functioning state of transmission link 10 may thus be achieved if, for example, the channels deviate from their original parameters due to thermal and/or mechanical effects, and this results in a change of range a. It is also possible in this way to ensure reliable monitoring in the case of gradual changes of the transmission parameters of transmission link 10 which occur over the course of the service life of the radar sensor.

Calculation unit 30, comparator 32, unit 36 and/or calibration unit 42 may be software units or software modules of data processing unit 14, for example.

The described monitoring is based on the fact that the signal drop by the value d is reliably detectable when the ratio of the signal drop to be detected to the “natural” variation of the signal levels is sufficiently large in the case in which the transmission link is functioning.

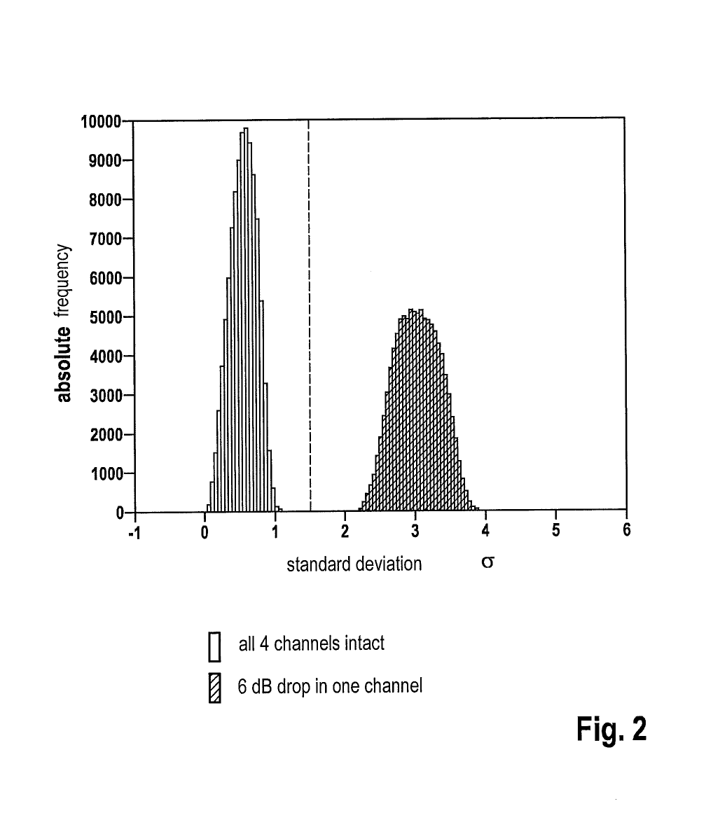

FIG. 2 illustrates the resulting variation of the logarithmic difference signal amplitudes based on simulated signal amplitudes for a predefined test signal. It shows the standard deviation of amplitudes x₁ through xₙ for the example having four channels, both for the case of an intact transmission link and for the case of a drop by 6 dB in one channel. It was assumed here that a natural variation of the channel amplitudes of 2 dB results in the functioning state of transmission link 10. In each case, the frequency of the standard deviation of the logarithmic difference signals ascertained on the receiving side is shown. Standard deviation a corresponds to the root of variance σ² calculated according to equation (2).

The value of a standard deviation is plotted on the x axis, and the absolute frequency of the occurrence of this standard deviation in the simulation is plotted on the y axis.

For the case in which transmission link 10 is functioning, obtained standard deviations a are in each case clearly below the value σₜₕ=1.5, which corresponds to threshold value σₜₕ² for variance σ² and is shown as a dotted line.

The standard deviations occurring with the simulated drop of a difference signal of one channel by 6 dB are hatched and are all above 1.5. Since there is no overlapping of the distributions whatsoever for both cases, a fault is already detectable clearly and accurately based on a single measurement of the difference signals.

FIG. 3 outlines a possible course of the method for monitoring the proper operational state of a transmission link and, for example, corresponds to the mode of operation of the monitoring device of the circuit according to FIG. 1, as it was described above.

When a monitoring cycle is triggered, the test signals are fed in step S10 into the channels of the transmission link at the first end of transmission link 10 to be monitored. The received signals are converted in step S12, digitized in step S14, and optionally corrected with the aid of correction values 40 in step S16.

The calculation of variance σ² according to equation (2) is carried out in step S18.

In step S20, calculated variance σ² is compared to threshold value σₜₕ². If the threshold value was reached, the corresponding function signal 34 is output in the form of a fault signal in step S22.

If the threshold value was not reached, in an additional step S24 optionally the minimum of the received difference signals is compared to a second threshold value, and in the event of a threshold value shortfall, second function signal 38 is output in the form of an error signal in step S26.

Otherwise, a comparison of range a of the difference signals to the calibration threshold value for the range follows optionally in step S28, and at least one new correction value 40 is determined for a channel in step S30 in the event of a threshold value shortfall.

A monitoring cycle is thus completed, and the operation of the transmission link is resumed.

While in the described example coupling capacitors 20, converters 22 and A/D converters 24 as well as data processing unit 14 are part of the circuit whose transmission link 10 is to be monitored, they may alternatively also be made available as a separate assembly. Function signal 34, and optionally second function signal 38, are then preferably output. For example, they may be output in the form of an interrupt signal to a device or a circuit whose transmission link is to be monitored. The test signal generator is then controlled by the implied device, for example.

Test signal generator 26 and/or switching device 28 is/are not necessarily (an) integral part(s) of the monitoring device. Test signals may also be made available externally, for example. Instead of test signals, optionally other signals may also be used for monitoring, provided these result in difference signals having a sufficiently low range a in the functioning state of the transmission link.

By measuring only the signals transmitted by the transmission link in the described monitoring device and the described method, but not a temperature, plant parameters or similar variables, for example, both the robustness of the monitoring may be increased and the manufacturing complexity for the monitoring device may be reduced. Robust and reliable monitoring of the proper operational state of the transmission link is especially important, in particular for safety-relevant applications of a radar sensor, such as an automatic emergency braking assistance system.

The monitoring device and the method have been described by way of example to illustrate the present invention using AC voltage coupling of the signals and to allow reliable fault detection for the cases of a signal drop in one through n channels. In a circuit having no coupling capacitors 20, the fault mechanisms of a conductor rupture or of a conductor interruption as well as of a short to ground are detectable in a corresponding manner by the caused signal drop by 6 dB. A malfunction in which a short of one or multiple channels to the supply voltage occurs and does not result in a drop, but in a signal rise, is also detectable, provided the signal rise of each channel caused by this is at least d; to detect a corresponding simultaneous failure of all channels, unit 36 then carries out a comparison of the maximum of the signal levels to an additional threshold value, for example.

1-11. (canceled)

12. A method for monitoring a proper operational state of a transmission link having multiple channels, each of which is configured for the differential transmission of signals, the method comprising:
feeding differential signals at a first end of the transmission link to be monitored;
converting signals received at a second end of the transmission link to be monitored into difference signals, one difference signal being formed for each channel; and
comparing a quality criterion which is dependent on a distribution of values of the difference signals of the channels to a threshold value.

13. The method as recited in claim 12, further comprising:
digitizing the formed difference signals.

14. The method as recited in claim 12, wherein the quality criterion depends on a variance of logarithms of the difference signals across the channels.

15. The method as recited in claim 12, wherein the threshold value in the comparing step is based on the number of the channels of the transmission link and a value of a signal change of one channel to be detected.

16. The method as recited in claim 12, wherein a quality criterion in the form of a variance
$${σ}^{2} = \frac{1}{n - 1} \cdot {\sum }_{i = 1}^{\text{?}} {( {x}_{i} - μ )}^{2}$$
$$\text{?} \text{indicates text missing or illegible when filed}$$
is compared to a threshold value
$${σ}_{\text{?}}^{2} = \frac{1}{n} \cdot {( \frac{d}{2} )}^{2} , \\ \text{?} \text{indicates text missing or illegible when filed}$$
n being the number of channels of the transmission link, x₁, . . . , xₙ being logarithms of the received difference signals; μ being a mean value of the logarithms of the received difference signals; and d being a logarithm of a drop of a difference signal to be detected in the case of a faulty channel.

17. A monitoring device for a transmission link having multiple channels, each of which is configured for differential transmissions of signals, the monitoring device comprising:
at least one converter for converting received differential signals of the transmission link to be monitored, the at least one converter being configured to form a difference signal for each channel; and
a comparator, which is configured to compare a quality criterion which is dependent on a distribution of values of the difference signals to a threshold value.

18. The monitoring device as recited in claim 17, further comprising:
at least one A/D converter for digitizing the formed difference signals.

19. The monitoring device as recited in claim 17, wherein the comparator is formed by a program unit of a processor-controlled data processing unit.

20. The monitoring device as recited in claim 17, further comprising:
a calculation unit for calculating the quality criterion from logarithms of the difference signals of the channels of the transmission link.

21. The monitoring device as recited in claim 17, further including:
at least one test signal generator for generating a test signal for the transmission link.

22. A multichannel radar sensor having at least one transceiver module for radar signals, wherein base band signals of the channels of the at least one transceiver unit are supplied to a data processing unit via a multichannel differential signal transmission link, and a monitoring device for the data transmission link, the monitoring device including at least one converter for converting received differential signals of the transmission link to be monitored, the at least one converter being configured to form a difference signal for each channel, and a comparator, which is configured to compare a quality criterion which is dependent on a distribution of values of the difference signals to a threshold value.
